(19) United States
(12) Patent Application Publication
(10) Pub. No.: US 2013/0083065 A1
(43) Pub. Date: Apr. 4, 2013

(54) FIT PREDICTION ON THREE-DIMENSIONAL VIRTUAL MODEL

(71) Applicant: Jessica Schulze, Littleton, CO (US)

(72) Inventor: Jessica Schulze, Littleton, CO (US)

(21) Appl. No.: 13/565,461

(22) Filed: Aug. 2, 2012

Related U.S. Application Data
(60) Provisional application No. 61/514,378, filed on Aug. 2, 2011.

(51) Int. Cl. G06T 19/00

(52) U.S. Cl. CPC G06T 19/006
USPC 345/633

(57) ABSTRACT

Systems and methods for conducting and providing a virtual shopping experience are disclosed. The disclosed systems and methods enable a customer to create a single instance of customer-specific dimension data and then securely utilize their dimension data to conduct virtual shopping sessions with a plurality of different and unrelated entities.

### CROSS-REFERENCE TO RELATED APPLICATIONS

This application claims the benefit of U.S. Provisional Patent Application Ser. No. 61/514,378, filed Aug. 2, 2011, the entire disclosure of which is hereby incorporated herein by reference.

### FIELD OF THE DISCLOSURE

The disclosure relates to electronic commerce and the utilization of fit predictions to facilitate the same.

### BACKGROUND

The design and selection of clothes for persons or objects by manufacturers, retailers and consumers can be a time consuming task. For example, the selection of clothing by a consumer often involves traveling between various brick-and-mortar department stores and clothing shops, along with finding and trying on different articles of clothing at each location to determine fit and aesthetic appearance. Often, a person does not know his or her exact clothing size or body measurements. This problem is exacerbated by clothing manufacturers that have developed their own system for sizing. When shopping alone, it is often difficult to determine the proper fit of clothing, especially since viewing the fit of clothing from all angles is not normally available to the shopper. Moreover, purchase decisions are often made in haste, since shoppers may feel uncomfortable with the lack of privacy associated with many fitting rooms.

Accordingly, it has become increasingly popular for consumers to use mail-order catalogs, television, and the Internet for purchasing clothing or other articles. Although such services offer more convenience to consumers, such as privacy, a relaxing home atmosphere, the avoidance of crowds and traffic, as well as 24-hour operation, the return of clothing items due to improper fit continues to be a problem with both the home shopping industry and stores where clothing is sold. Specifically, many mail-order and online retailers report returns on up to 40% of all purchases.

There have been advances in virtual fitting rooms where a customer is allowed to virtually try on clothes. Most existing virtual fitting rooms, however, are limited in that they can only be used at a single clothing retailer. In fact, most virtual fitting technology is used by custom clothing retailers to help the customer visualize the custom fit clothing, thereby justifying its increased cost. The primary problem is that most customers do not want their dimensions made publicly available and most retailers that do offer virtual fitting rooms do not want to share the customer's dimensions because the retailers view this data as proprietary, even though it is personal to the customer and is the customer's data. Accordingly, most customers will need to be re-scanned by each retailer if they want to have a virtual fitting session with that retailer's goods. This is at least one reason why virtual fitting rooms have not become widely available.

### SUMMARY

Embodiments of the present disclosure are directed toward methods and systems for facilitating virtual fitting sessions whereby a virtual model of a customer (e.g., an Avatar) is fit with a virtual model of a garment, shoe, accessory, or other type of wearable article. In particular, a system and method are disclosed which enables a single source of dimension data for a customer to be securely disseminated to a plurality of different retailers or service providers. Utilization of a single source of dimension data for a customer enables the customer to conduct virtual fitting sessions with a number of different unrelated entities (e.g., various clothing retailers, shoe retailers, accessory retailers, tailors, seamstresses, cobblers, etc.) regardless of whether or not the entities are primarily a brick-and-mortar-based entity or a web-based entity.

Furthermore, the dimension data for the customer is maintained securely so that the customer does not have to worry about their private dimension data being publicly available without the customer's consent. Rather, in some embodiments, the dimension data for the customer is only made available to the unrelated entities for a specific transaction or for a specific time and only after receiving permission from the customer to release the dimension data for that specific transaction or specific time. The extent to which the dimension data for the user is disseminated to other entities is controlled by one or more security mechanisms (e.g., encryption algorithms, hash functions, etc.), each of which may be controlled by the user at a central location at any given point in time.

In some embodiments, the entity that originally captures the dimension data (e.g., the measuring entity) may utilize one or more image-capturing systems. The image-capturing systems may be portable (e.g., placed on a van, truck, trailer, etc.) or fixed (e.g., a kiosk, booth, building, etc.).

In some embodiments, an image-capturing system is configured to capture the dimension data for the customer by taking one or more pictures of the customer, performing various image-processing techniques on the captured image(s), and then determining dimensions of the customer based on the outputs of the image-processing techniques. The dimensions of the customer may then be used to create a virtual representation of the customer (e.g., an Avatar). The virtual representation of the customer may then be utilized to facilitate virtual fitting sessions whereby a wearable article is fit onto the appropriate location of the virtual representation of the customer and the virtual representation of the customer with the wearable article is displayed to the customer via a graphical user interface (GUI).

Any number of virtual fitting techniques may be employed without departing from the scope of the present disclosure. As some non-limiting examples, the virtual fitting techniques described in the following U.S. patents or patent publications, each of which are hereby incorporated herein by reference in their entirety, may be used: 7,953,648; 7,584,794; 7,479,956; 7,149,665; 6,546,309; 6,307,568; 2009/0018926; 2008/0163054; 2007/0005171; 2004/0049309; 2002/0130890; and 2002/0126132.

In addition to enhanced security, there are other advantages to having a single source of dimension data. As one example, a customer may be allowed to update their dimension data at a single location (e.g., via a web interface) rather than having to update multiple instances of dimension data with a number of different retailers. As another example, a customer can enter the same virtual fitting room (e.g., a familiar virtual environment) where the user controls are in the same location, regardless of whether the customer is trying on garments from a department store, earrings from a jewler, or shoes from a boutique. This familiarity will help to increase customer comfort and enhance the customer's shopping experience.

In some embodiments, the flow of data between a fitting entity and a selling entity may be unidirectional. Specifically, the flow of data may be conditioned such that only dimension data for merchandise is provided from the sellingentity to the fitting entity. This unidirectional flow of data helps the fitting entity assure the customer that their private dimension data will not be shared outside of the fitting entity.

In some embodiments, it may be desirable to provide non-sensitive data from a fitting entity back to a selling entity. For instance, if the selling entity is unaware of the dimension data for their customers (e.g., the customers that are virtually trying on their merchandise), then it may be useful to provide some amount of fitting feedback from the fitting entity to the selling entity. As a non-limiting example, the fitting entity may have information about certain garments that have been tried on by a number of customers and may have fitting results based on the virtual fitting session. If the fitting entity observes that customers of a certain body type are trying on a certain garment offered by a selling entity, but that a low percentage (e.g., less than 5%) of the customers are purchasing the garment, then the fitting entity may generally inform the selling entity that it may be advantageous to re-size that particular garment to accommodate the body type of those customers that are trying on the garment. Such feedback information may be found useful by the selling entity to re-dimension their garment(s) and hopefully capitalize on a greater number of sales. All of this feedback information can be provided to the selling entity without exposing any sensitive dimension data for the customers to the selling entity.

Alternatively, or in addition, a customer's dimension data may be provided from the fitting entity back to the selling entity, but any personal information (e.g., identification information) may be scraped from the dimension data before it is provided to the selling entity. Such clean dimension data may be provided before or after a virtual fitting session is executed.

In some embodiments, a method is provided that generally comprises:
obtaining one or more images of a customer;
transforming scanned vertex data from the one or more images into Avatar data configured to create a dimensional mesh model of the customer;
securely storing the Avatar data; and
conditioning release of the Avatar data upon receiving a valid password.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram depicting entities involved in a virtual shopping session in accordance with embodiments of the present disclosure;

FIG. 2 is a block diagram of an image-capturing system in accordance with embodiments of the present disclosure;

FIG. 3 is a block diagram of a communication system which facilitates a virtual shopping experience in accordance with embodiments of the present disclosure;

FIG. 4 is a block diagram depicting components of a client device in accordance with embodiments of the present disclosure;

FIG. 5 is a block diagram depicting a data structure used in accordance with embodiments of the present disclosure;

FIG. 6 is a flow diagram depicting a data gathering method in accordance with embodiments of the present disclosure;

FIG. 7 is a flow diagram depicting a virtual shopping method in accordance with embodiments of the present disclosure;

FIG. 8 shows a first screen shot of a user display during a web-based shopping session in accordance with embodiments of the present disclosure;

FIG. 9 shows a second screen shot of a user display during a web-based shopping session in accordance with embodiments of the present disclosure;

FIG. 10 shows a third screen shot of a user display during a web-based shopping session in accordance with embodiments of the present disclosure;

FIG. 11 shows a fourth screen shot of a user display during a web-based shopping session in accordance with embodiments of the present disclosure; and

FIG. 12 is a flow diagram depicting messages which may be exchanged between servers to facilitate a web-based shopping method in accordance with embodiments of the present disclosure.

### DETAILED DESCRIPTION

The disclosure will be illustrated below in conjunction with an exemplary communication system. Although well suited for use with, e.g., a system using a server(s) and/or database(s), the disclosure is not limited to use with any particular type of communication system or configuration of system elements. Those skilled in the art will recognize that the disclosed techniques may be used in any communication application in which it is desirable to provide a virtual shopping experience.

The systems and methods of this disclosure will also be described in relation to analysis software, modules, and associated analysis hardware. However, to avoid unnecessarily obscuring the present disclosure, the following description omits well-known structures, components and devices that may be shown in block diagram form, are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

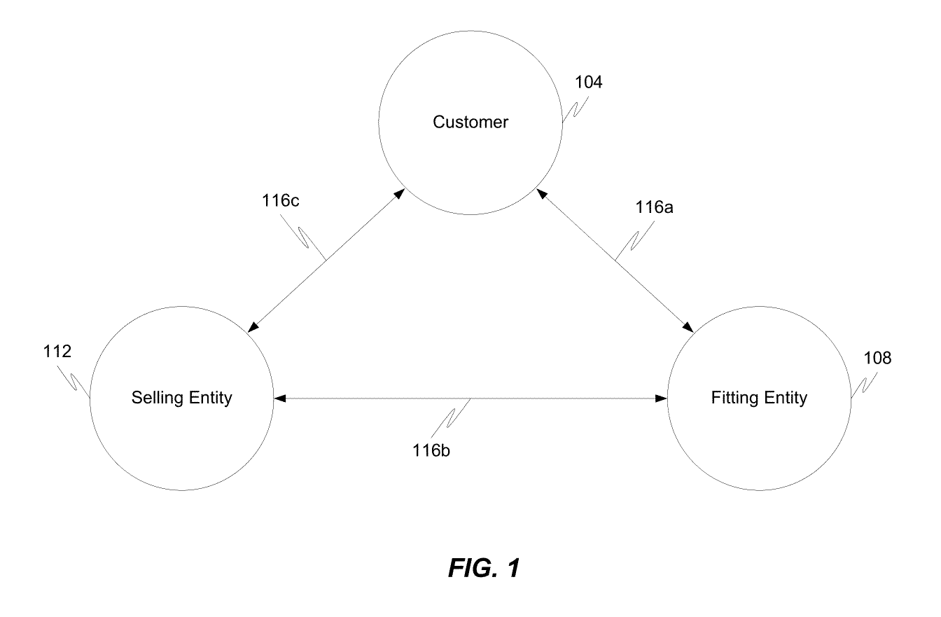

Referring initially to FIG. 1, the entities which may be involved in a web-based shopping experience will be described in accordance with embodiments of the present disclosure. In some embodiments, a customer 104 may be allowed to interact simultaneously with a selling entity 112 and a fitting entity 108. The customer 104 may represent any person, group of persons, business, entity, or otherwise that are interested in purchasing one or more goods from the selling entity 112. Accordingly, the selling entity 112 may include any person, group of persons, business, entity, or otherwise that is sells one or more goods and/or services. In some embodiments, the selling entity 112 may establish a web-based store for selling their goods and/or services. The web-based store may be established in addition to any brick-and-mortar stores that are established by the selling entity 112.

The fitting entity 108 may be related or unrelated to the selling entity 112. In some embodiments, the fitting entity 108 is unaffiliated with the selling entity 112 and, therefore, may establish its own web-based presence. In some embodiments, the fitting entity 108 may be part of the selling entity 112 or it may be a subsidiary of the selling entity 108.

A number of communication links 116a, 116b, 116c may be established between the various entities described herein. A first communication link 116a may be used to exchange communications between the customer 104 and fitting entity 108. A third communication link 116c may be used to exchange communications between the customer 104 selling entity 112. These communications links, in some embodiments, may facilitate the exchange of electronic messages, data packets, etc. between the entities. The communication links may also, or alternatively, facilitate real-time communications via bearer channels (e.g., voice or video bearer channels).

In embodiments where the fitting entity 108 is separate from the selling entity 112, a second communication channel 116b may be used to exchange communications between the fitting entity 108 and selling entity 112. In some embodiments, the second communication channel 116b may be secured to facilitate the exchange of encrypted or otherwise secured communications between the fitting entity 108 and selling entity 112. As a non-limiting example, the first and third communication links 116a, 116b may not necessarily be secured and may be used to exchange communications via a well-known data exchange protocol (e.g., Hyper Text Transport Protocol (HTTP) or Real-Time Transport Protocol (RTP)).

The second communication link 116b, on the other hand, may utilize a secured data exchange protocol (e.g., secured HTTP (HTTPS) or secured RTP (SRTP)). Likewise, if the customer 104 decides to finalize a purchase with the selling entity 112, then the third communication link 116c may be transformed into a secured communication link for purposes of completing the purchase.

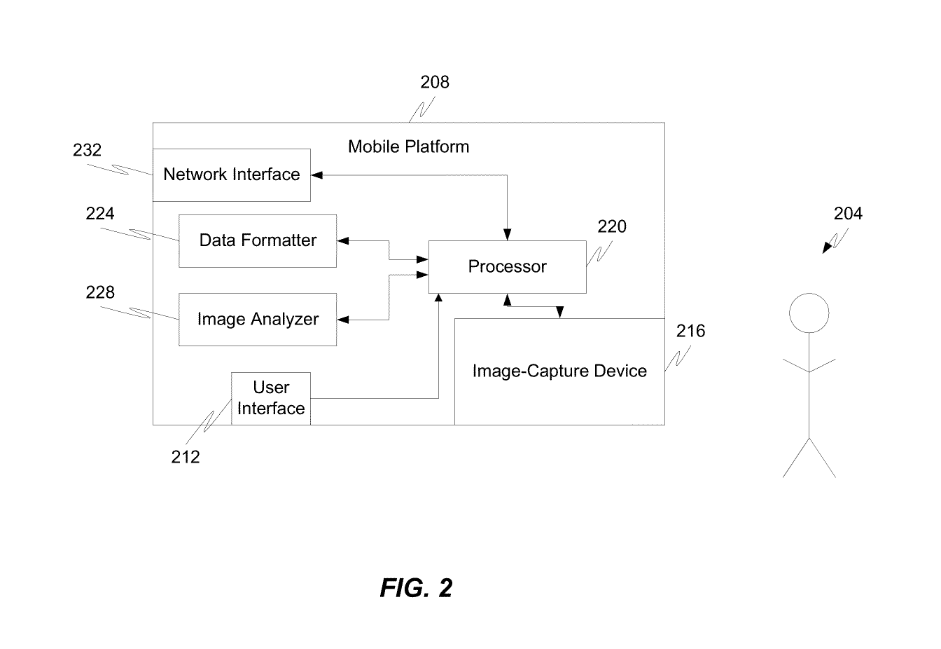

With reference now to FIG. 2, a system for capturing and storing customer dimension data will be described in accordance with embodiments of the present disclosure. In some embodiments, the system depicted in FIG. 2 is owned and operated by the fitting entity 108 and may not necessarily be directly accessible to the selling entity 112 without interfacing with the fitting entity 108 (e.g., via the second communication link 116b). The system may include a platform 208 that includes an image-capture device 216, a user interface 212, a processor 220, a data formatter 224, an image analyzer 228, and a network interface 232. Each component in the platform 208 may be used to capture one or more images of a customer 204 and transform the captured image(s) into customer dimension data.

As seen in FIG. 2, the platform 208 may be a mobile platform 208, which means that the platform is mobile and capable of easily moving its components from place to place. Examples of a mobile platform 208 include, without limitation, a truck, van, trailer, car, SUV, or any other vehicle with wheels. It is also feasible to have a non-mobile or fixed platform that is in the form of a kiosk, brick-and-mortar store location, etc. Depending upon the type of platform used, different types of components may be included in the platform 208. As an example, when the platform 208 is mobile, the network interface 232 may be a wireless network interface (e.g., network card connected to an antenna or plurality of antennas) configured to exchange data with a broader communication network via a wireless data exchange protocol (e.g., any variant of GSM, any variant of the IEEE 802.11 standard, etc.). Conversely, if the platform 208 is not mobile, then the network interface 232 may comprise a wired network interface (e.g., a network card connected to a physical communication port) configured to exchange data with a broader communication network via a wired data exchange protocol (e.g., Ethernet).

In some embodiments, the image-capture device 216 may comprise one or more cameras, video cameras, infrared cameras, etc. that are capable of capturing one or more images of the customer 204. The images captured by the image-capture device 216 may by transferred to the processor 220 which invokes the image analyzer 228 to convert the image data to dimension data. In particular, the image analyzer 228 may comprise functionality that converts the scanned vertex data contained within the images into physical dimensions (e.g., feet, inches, meters, centimeters, etc.). The image analyzer 228 may also determine points of interest on the customer 204 and identify approximate physical distances between such points of interest. As one example, the image analyzer 228 may build a 3-dimensional mesh model of the customer 204 based on the pixel data obtained from the image(s) of the customer.

The data formatter 224 may be configured to transform the data output by the image analyzer 228 into a format suitable for safe storage. In some embodiments, the data formatter 224 may comprise an encryption engine or similar algorithm suitable for converting the customer's dimension data into a secure format. The data formatter 224 may also be configured to compress the data output by the image analyzer 228 such that the data is better formatted for storage in a database. As one non-limiting example, the data formatter 224 may comprise functionality suitable for encrypting the customer's dimension data (e.g., an MD5 hash, DES, AES, RSA, variants thereof, or modifications thereto). The data formatter 224 may either encrypt the customer's dimension data with an encryption key from a symmetric private key pair or a private encryption key from an asymmetric public/private key pair. In the latter embodiment, the data formatter 224 may utilize information obtained from the customer 204 via the user interface 212 to generate the private key (e.g., a user-provided password) and a public key counterpart may be generated for distribution to various selling entities 112.

The user interface 212 may comprise any functionality capable of receiving input from the customer 204 (e.g., keyboard, touchpad, microphone, pointer device, etc.) as well as functionality for providing outputs to the customer 204 (e.g., screen, speaker, lights, etc.). The user interface 212 may provide the customer 204 with a convenient way of establishing a trusted relationship with the fitting entity 108 when the customer's 204 dimension data is processed by the mobile platform 208. In particular, when a customer 204 is scanned and the dimension data is obtained, the customer 204 may also establish a trusted relationship with the fitting entity by creating a profile on the fitting entity's website and also establishing security preferences for their dimension data. This input data may be stored along with the customer's dimension data according to security preferences established by the customer. Such security preferences may be default preferences or customer-specified preferences.

As a non-limiting example, the mobile platform 208 may comprise functionality similar or identical to the NX-16 3D scanner produced and sold by [TC]²®. In particular, the mobile platform 208 may comprise a truck or van equipped with such a body scanner and image-processing equipment.

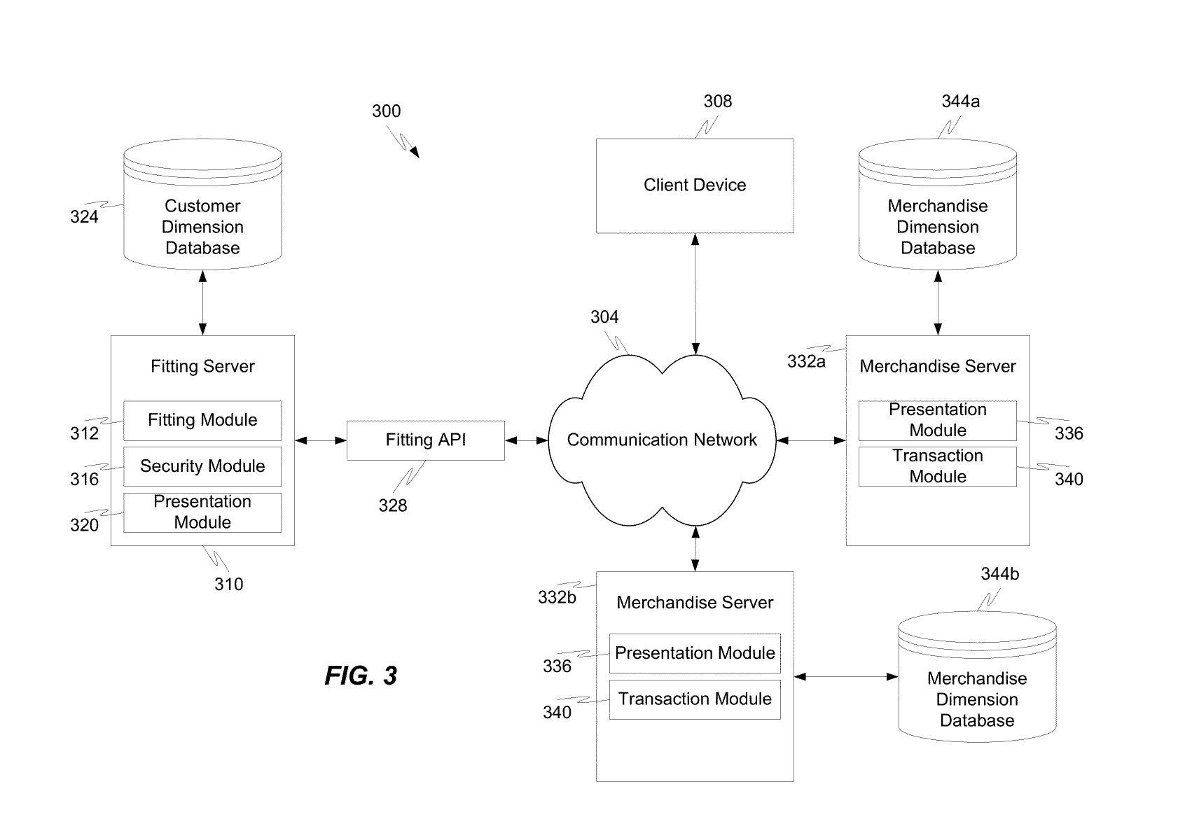

With reference now to FIG. 3, a non-limiting example of a communication system 300 that can be used to facilitate a customer's web-based shopping experience with a selling entity 112 and fitting entity 108 will be described. The communication system 300 may comprise a communication network 104 that interconnects a fitting server 310 (e.g., a webserver hosted or operated by the fitting entity 108) with one or more merchandise servers 332a, 332b (e.g., webservers hosted or operated by various selling entities 112).

The communication network 304 may comprise any type of Local Area Network (LAN), Wide Area Network (WAN), or combinations thereof. One example of a suitable communication network 104 is the Internet.

The fitting server 310 and merchandise servers 332a, 332b may comprise a single server or a server cluster connected to the communication network 104. In some embodiments, each different selling entity 112 may host a different merchandise server 332. Accordingly, although only two different merchandise servers 332a, 332b are depicted, it should be appreciated that the communication network 300 may comprise three, four, five, six, or more different merchandise servers, each of which are hosted or operated by different selling entities 112.

The fitting server 310 may comprise a fitting module 312, a security module 316, and a presentation module 320. The fitting server 310 may also be connected to a customer dimension database 324 that is used to store the dimension data for various customers that has been obtained by the customer either directly (e.g., through user interface 212) or indirectly (e.g., through a web interface).

In some embodiments, the customer dimension database 324 stores customer dimension data in a secured format and is only capable of retrieving or releasing such data if a proper password is provided either by the customer 104 or a selling entity 112. Specifically, the security module 316 may comprise the functionality required to maintain the customer dimension data securely in the customer dimension database 324. Unless a valid password or key is provided to the security module 316, then the security module 316 may prohibit access to the customer dimension database 324.

The fitting module 312 may comprise the functionality to virtually fit a customer's 3-dimensional model (e.g., an Avatar) with a 3-dimensional model of merchandise. The presentation module 320 may comprise the functionality for presenting a virtual fitting room to the customer via a webpage sent to the client device 308. In some embodiments, the presentation module 320 may be configured to serve one or more webpages to the client device 308 by using one or more languages such as HTML, XML, JAVA® script, QuickTime®, Flash®, etc. Thus, the presentation module 320 is responsible for presenting the customer 104 with a virtual fitting room that is the same regardless of the merchandise server 332a, 332b that provided the merchandise dimension data. The fitting module 312, on the other hand, is responsible for actually fitting the virtual merchandise to the virtual customer. The fitting module 312 may also be configured to determine a “goodness of fit” based on how well the virtual merchandise fit the virtual customer.

Each of the merchandise servers 332a, 332b may comprise a presentation module 336 and a transaction module 340. Moreover, the merchandise servers 332a, 332b may be connected to a respective merchandise dimension database 344a, 334b. The data used to generate a virtual model of the merchandise for the virtual fitting session may be obtained from the merchandise dimension database 344a, 344b. The presentation module 336 may be similar to the presentation module 320 in that the presentation module 336 is responsible for presenting the webpages offered by the merchandise server 332a, 332b to the client device 308 operated by the customer 104. Thus, the presentation module 336 may facilitate a web-based shopping session where the customer 104 is allowed to view various pieces of merchandise offered by the selling entity 112. The presentation module 336 may also present a link (e.g., URL link, executable command, etc.) that directs the customer to the fitting server 310 to establish a virtual fitting session.

The transaction module 340 may comprise functionality for establishing a secure connection with the client device 308 so that the customer 104 can complete a web-based transaction with the selling entity 112 via their merchandise server 332. Any type of known secure transaction module 340 may be employed without departing from the scope of the present disclosure. It may also be possible that the transaction module 340 invokes a trusted third party's webserver to complete the transaction.

In some embodiments, the fitting server 310 may be configured to interface with each of the different merchandise servers 332a, 332b via a fitting Application Programmer's Interface (API) 328. The fitting API 328 may expose the services or functions of the fitting server 310 to the various merchandise servers 332a, 332b. In some embodiments, the different merchandise servers 332a, 332b may not necessarily employ the same communication protocols or data structures, and the fitting API 328 may provide a mechanism for these different merchandise servers 332a, 332b to access and utilize the functions of the fitting server 310.

In some embodiments, the fitting API 328 may perform translation functions for translating requests or commands received from the various merchandise servers 332a, 332b into a language understood by the fitting server 310. For example, the fitting API 328 may comprise a plurality of XML commands that are understood by the fitting server 310 and each of the XML commands can be mapped to different HTTP commands that are provided by different merchandise servers. Thus, if the merchandise servers 332a, 332b send HTTP-based commands toward the fitting server 310, then the fitting API 328 may convert the HTTP-based commands to the appropriate XML commands. Likewise, XML commands sent by the fitting server 310 can be converted by the fitting API 328 to one or more HTTP commands that are sent to the appropriate merchandise server. As can be appreciated, any number of other command structures may be supported by the fitting API 328. As another example, each of the selling entities may use different merchandise data formats (e.g., different types or formats of data for building a 2 or 3-dimensional model of the selling entities' merchandise) and the fitting API 328 may be configured to convert the different merchandise data formats into a common format that is compatible with the format of the customer dimension data. This conversion of merchandise dimension data may enable the fitting module 312 to properly “fit” the virtual merchandise to the virtual customer. With the fitting API 328, it may not be possible to facilitate fitting sessions with different selling entities 112 by using a single instance of customer dimension data.

It may not always be necessary to employ a fitting API 328, however. For example, if the customer dimension data is made available or sent to each of the different merchandise servers 332a, 332b (e.g., when a valid password is received therefrom) or if the fitting entity 108 and selling entity 112 are one and the same, then there may not be a need for a fitting API 328.

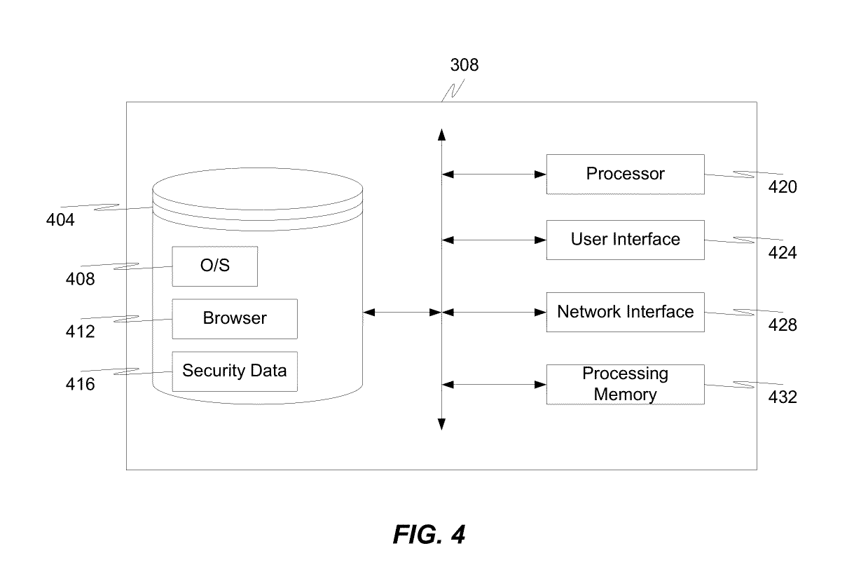

With reference now to FIG. 4, additional details of a client device 308 will be described in accordance with embodiments of the present disclosure. The client device 308 may comprise any type of communication device that facilitates a customer's 104 interaction with the fitting server 310 and/or merchandise server 332a, 332b. Examples of suitable client devices 308 include, without limitation, a personal computer, a laptop, a tablet, a smart phone, a cellular phone, a thin client, a kiosk, a telephone, or the like.

In some embodiments, the client device 308 may comprise local memory 404 that includes an Operating System (O/S) 408 (e.g., Windows®, Linux, any variant of Mac OS X®, Unix, etc.), a browser 412 (e.g., Internet Explorer®, Safari®, Mozilla Firefox, Google Chrome®, etc.), and security data 416. The security data 416 may comprise any data that is input by the customer 104 and is used for security the customer's dimension data. More specifically, the customer 104 may be allowed to store their security data 416 locally on the client device 308 so that the client device 308 can provide the security data 416 to the fitting server 310 when required for establishing a virtual fitting session. Without the security data 416, the fitting server 310 may not be allowed to access or decrypt the customer's dimension data and, therefore, may not be enabled to present the customer with a virtual fitting session.

The client device 308 may also comprise a processor 420, a user interface 424, a network interface 428, and processing memory 432. In some embodiments, the processor 420 may comprise any digital processor or collection of processors capable of executing the instructions stored in memory 404.

The user interface 424 may comprise any type of known user input device (e.g., keyboard, button, pointer device, touchpad, microphone, etc.), user output device (e.g., screen, light, speaker, etc.), or combination user input/output device (e.g., touchscreen). The user interface 424 may provide the mechanism for presenting the user with visualizations of the virtual fitting session provided by the fitting server 310 and/or visualizations of the shopping session provided by a merchandise server 332a, 332b.

The network interface 428 may comprise functionality that enables the client device 308 to connect or otherwise communication data with other devices via the communication network 304. The network interface 428 may be wired or wireless and, in some embodiments, may comprise a card (e.g., Network Interface Card (NIC)) that includes modulation/demodulation components. A suitable network interface 428 may include any example of a suitable network interface discussed in connection with the network interface 232.

The processing memory 432 and memory 404 may comprise any type of known memory device. One or both may be volatile or non-volatile in nature. Examples of memory types which may be used for one or both types of memory include, without limitation, Read Only Memory (ROM), variants of ROM (PROM, EPROM, EEPROM), Random Access Memory (RAM), Static RAM (SRAM), Dynamic RAM (DRAM), Flash memory, etc.

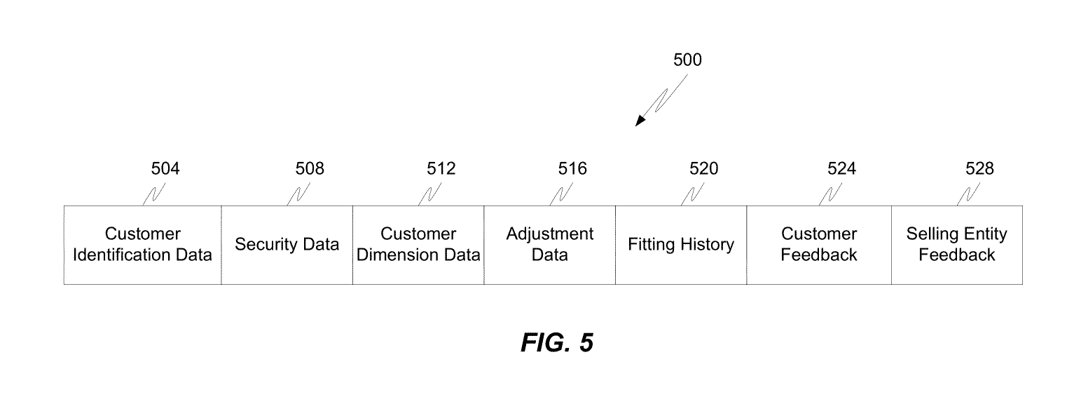

With reference now to FIG. 5, an example of a data structure 500 that may be employed to facilitate a virtual fitting session will be described in accordance with embodiments of the present disclosure. The data structure 500 may comprise a number of fields for storing data related to a customer or data that is usable by a customer 104, fitting entity 108, and/or selling entity 112 in connection with a virtual fitting session. The data structure 500 may be stored in whole or in part in the client device 308, in the fitting server 310, in the customer dimension database 324, in the merchandise server 332, in the merchandise dimension database 344, or combinations thereof.

As some non-limiting examples, the data structure 500 may comprise a customer identification data field 504, a security data field 508, a customer dimension data field 512, an adjustment data field 516, a fitting history field 520, a customer feedback field 524, and a selling entity feedback field 528.

The customer identification data field 504 may store information for uniquely or semi-uniquely identifying a customer 104. In some embodiments, the customer identification data field 504 may comprise data that is specific to identifying a customer at the fitting entity 108. For example, a customer's name, address, etc. may be stored in addition to the customer's user ID, alias, etc. Other types of customer identification information may be stored in the customer identification data field 504 such as telephone number, IP address, MAC address, browser cookies, and the like.

The security data field 508 may comprise any type of data which is used to securely store the customer's dimension data with the fitting server 310. As some examples, the security data field 508 may store user password data, encryption key data (public or private encryption keys), and the like.

The customer dimension data field 512 may comprise the data output by the image analyzer 228 and/or the data output by the data formatter 224. In some embodiments, the customer dimension data field 512 may store the customer's image data that was used to generate the customer's dimension data or it may actually store the dimension data computed based on the customer's image data. Alternatively, or in addition, the customer dimension data field 512 may store information for displaying a customer's Avatar (e.g., 3-dimensional data mesh) via a computer interface.

The adjustment data field 516 may comprise data that can be used to dynamically adjust the customer dimension data. In some embodiments, a customer may be allowed to enter data with the fitting server 310 that indicates that the customer's body shape (e.g., height, weight, proportions, waist, bust, neck, age, etc.) has changed since the last time the customer had their images captured by the platform 208. In this way, the customer dimension data 512 can be updated without requiring the customer to be re-scanned. Alternatively, or in addition, the adjustment data field 516 may comprise additional images captured of the customer from either a private image (e.g., pictures taken by the customer and not shared publicly) or public image (e.g., pictures taken and made available on a publicly-available forum such as a social network website, etc.) taken without the platform 208.

The fitting history field 520 can be used to store information related to a customer's history of virtual fitting sessions. In particular, information related to the customer's interactions with the fitting server 310 and/or merchandise server 332 may be stored in the fitting history field 520. The types of merchandise (e.g., clothes, shoes, jewelry, purses, hats, etc.) tried on by the customer in a virtual setting could be maintained in the fitting history field 520.

The customer feedback field 524 can be used to store any type of customer feedback information. The customer feedback information can be obtained directly from the customer (e.g., via a customer feedback survey) or indirectly (e.g., by analyzing a customer's return history of merchandise that was tried on in a virtual fitting session). For indirectly obtained feedback information, it may be possible to interpret that a customer has positive fit feedback if the merchandise is not returned where it can be inferred that a customer has negative fit feedback if the merchandise is returned.

The selling entity feedback field 528 may store information that is similar to the customer feedback field 524 except that the information is obtained either directly or indirectly from a selling entity 112 rather than a customer. A customer's return history may also be stored in this data field, except that the return history may be provided to the fitting entity 108 from the selling entity 112 when the customer returns a piece of merchandise.

Data in the data fields 512, 516, 520, 524, 528 can be used by the fitting module 312 to determine a goodness of fit that is specific to a customer's inferred fit preference. Specifically, a baseline or default fit preference may be used by the fitting module 312 initially, but as a customer's fit preference is determined (based on feedback information and other evolving data is obtained), a more precise fit preference can be determined. This customer-specific fit preference can then be used by the fitting module 312 to determine a goodness of fit during a virtual fitting session and provide recommendations to a customer for whether a particular piece of merchandise will fit the customer's preferences. This is particularly useful because it may be possible that two customers have substantially similar dimensions (e.g., actual customer dimension data), but the first customer has a first fit preference while the second customer has a second fit preference. This means that the first customer may find a piece of merchandise to fit well whereas the second customer may not find the same piece of merchandise to fit well because of the different fit preferences. By tracking historical fit data and other metrics, the fitting module 312 can determine updated fit preferences that are customer specific and, therefore, more useful.

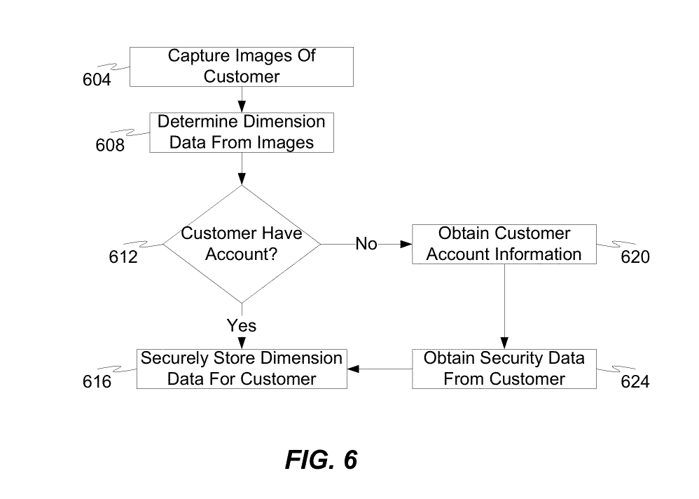

With reference now to FIG. 6, a method of capturing one or more images of a customer and obtaining customer dimension data thereby will be described in accordance with embodiments of the present disclosure. The method is initiated when one or more images of a customer are captured (step 604). The images may be captured by the image-capture device 216 on the platform 208 or they may be captured by a separate image-capture device (e.g., one that is owned and operated by the customer).

The method continues when the images are passed to the image analyzer 228 where the scanned vertex data from the image(s) is converted into dimensional data (step 608). During this step, it may also be possible to create a 3-dimensional mesh of the customer based on the relative physical dimensions obtained from the pixel data. In some embodiments, the 3-dimensional mesh may be considered an Avatar of the customer.

Thereafter, it is determined whether or not the recently-scanned customer has an account (e.g., has established a trusted relationship) with the fitting entity 108 (step 612). If this query is answered affirmatively, then the new customer dimension data is stored in the customer dimension data field 512 and/or the adjustment data field 516 for the data structure 500 that is specifically designated for that customer (step 616). If, however, the customer has yet to set up an account with the fitting entity 108, then account information is obtained from the customer (step 620) as well as any security data that will be used to securely store the customer dimension data (step 624). Once the customer's account has been setup based on the received information, the method continues to step 616.

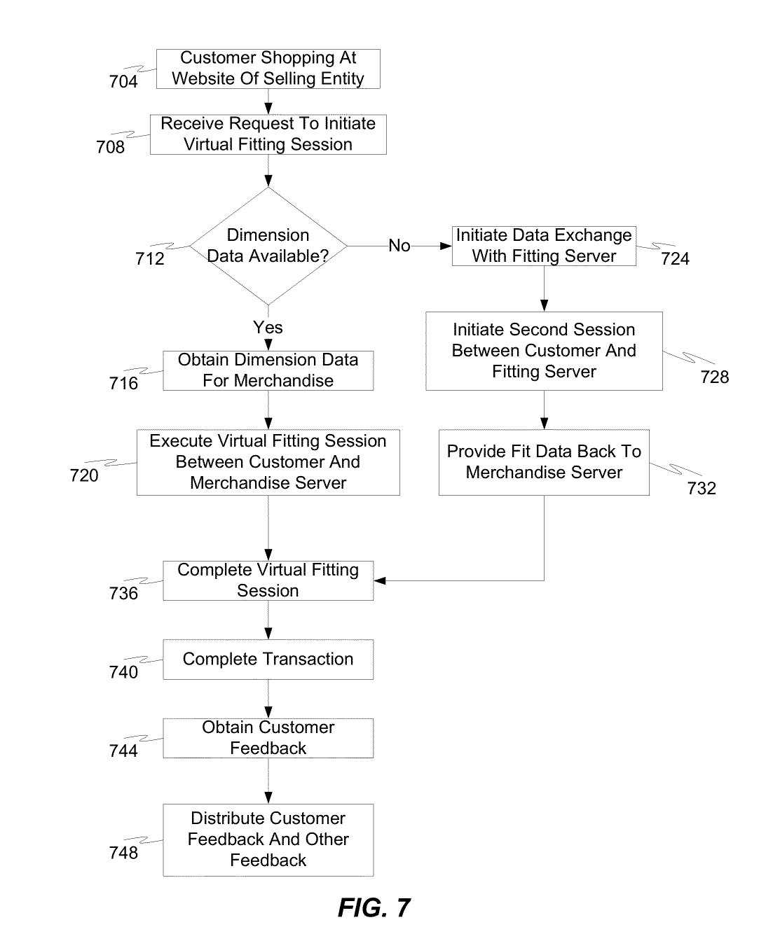

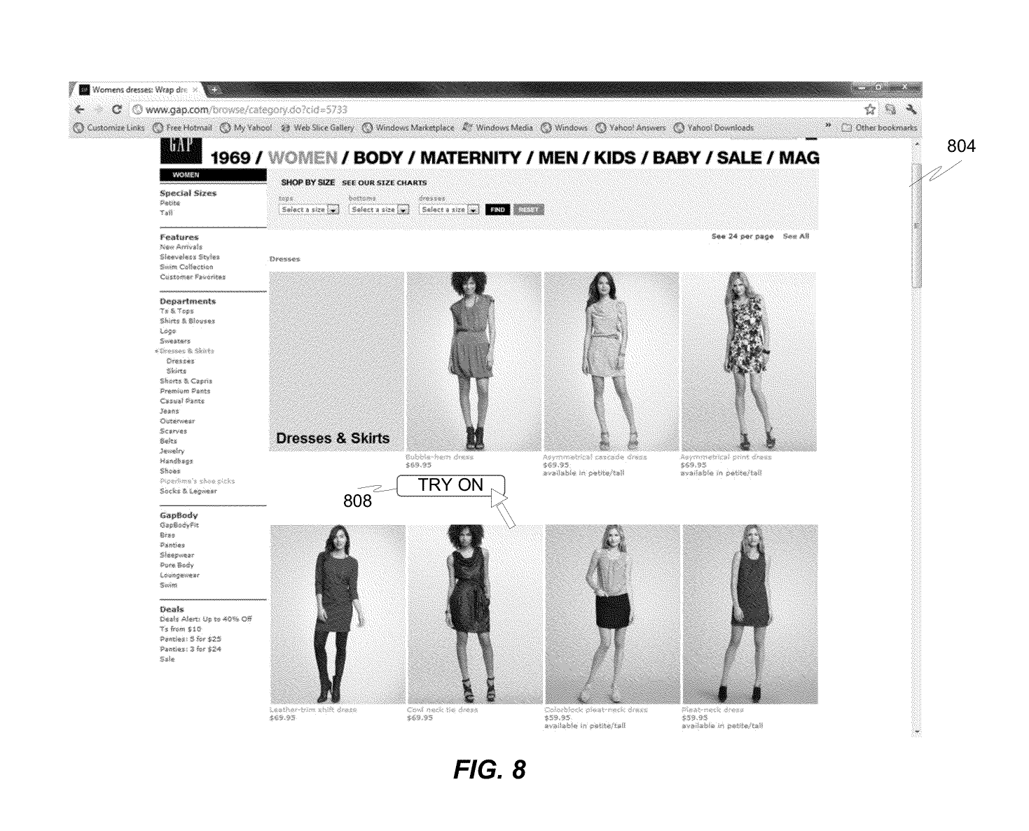

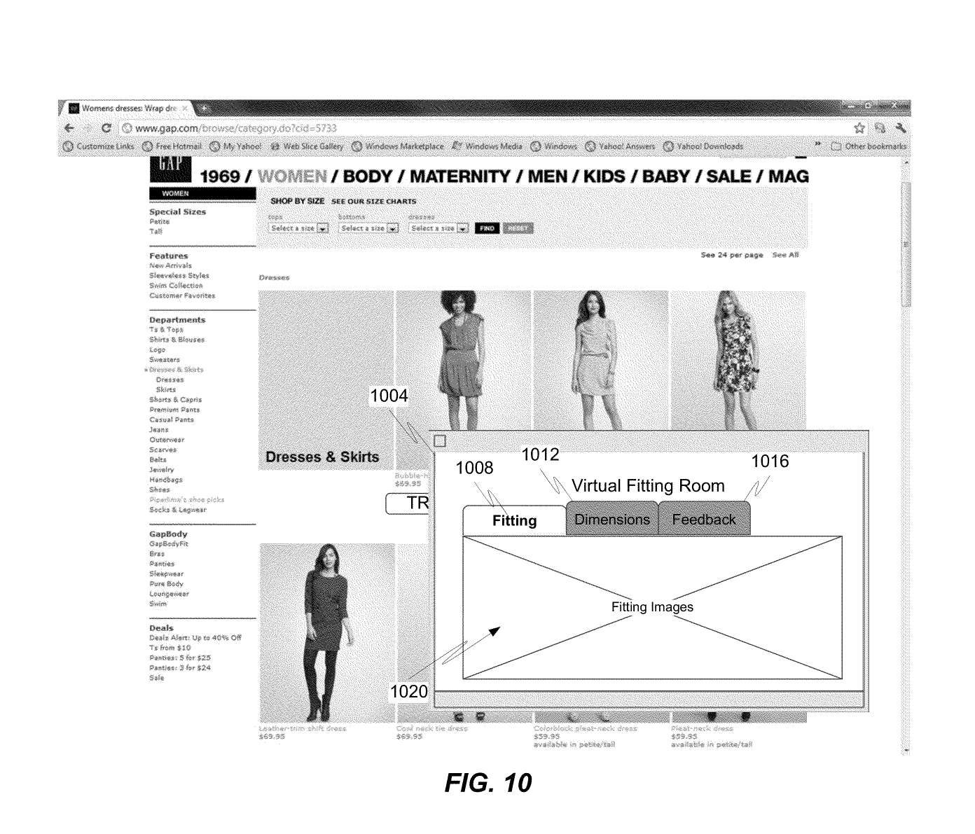

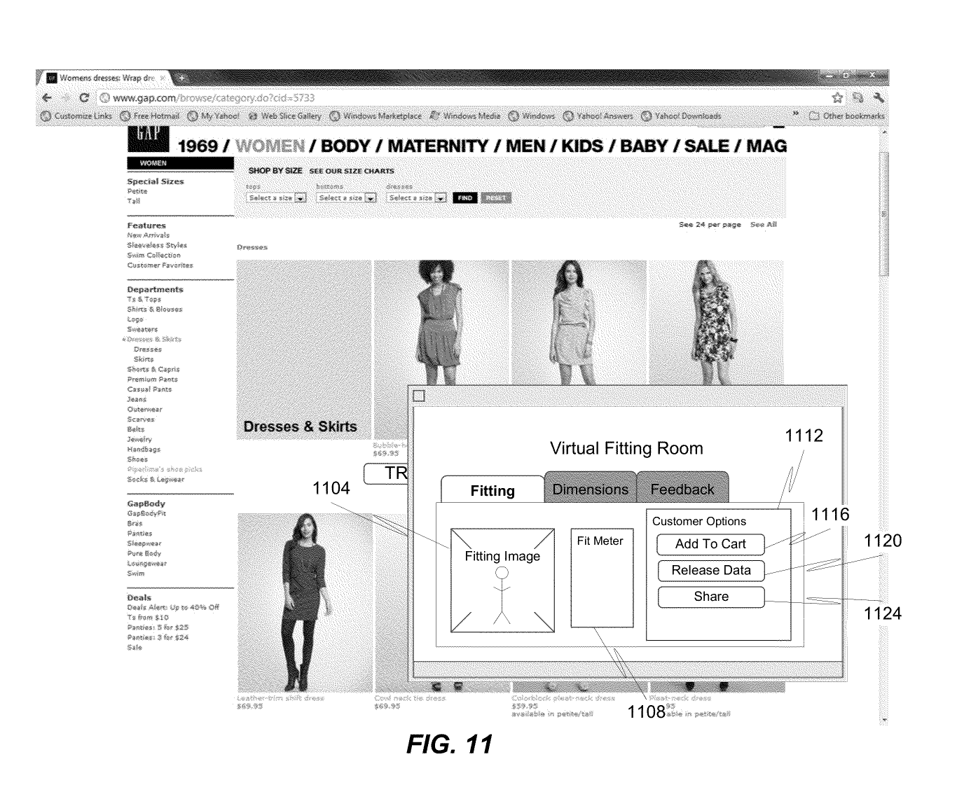

With reference now to FIGS. 7-12, additional details of a virtual fitting session will be described in accordance with embodiments of the present disclosure. A virtual fitting session can begin while a customer is using their client device 108 to interface with either the fitting server 310 or a merchandise server 332 in a web-based data communication session. In the embodiments depicted herein, a customer establishes a first web session with a selling entity 112 in which the customer is allowed to browse the various offerings of the selling entity 112 (step 704) (FIG. 8). Specifically, the customer can request one or more webpages 804 from a merchandise server 332 to view one or more pieces of merchandise that are sold by the selling entity 112.

While conducting this first web session, the selling entity 112 may provide the customer with an option to request a virtual fitting session. The option may be provided to the customer in the form of a try on button 808. The button may comprise a hyperlink or some other button that initiates a second web session. The method continues when the merchandise server 332 receives a request to initiate the virtual fitting session (e.g., the customer selects the try on button 808) (step 708).

Thereafter, it is determined whether or not the customer's dimension data is available directly to the merchandise server 332 (step 712). If so, then the merchandise server 332 can simply obtain the merchandise dimension data from the merchandise dimension database 344 (step 716) and then obtain the locally-available customer's dimension data to execute a virtual fitting session (step 720). During the virtual fitting session, the customer may be provided with images 1104 that depict an virtual fitting of the merchandise on the customer's Avatar, thereby allowing the customer to view how the merchandise will likely look on them when worn. Furthermore, a fit meter 1108 can be displayed to the customer. The fit meter may comprise a graphical and/or numerical representation of the estimated way in which the merchandise will meet the customer's fit preferences. Furthermore, different graphical and/or numerical representations may be provided for the customer's upper half and the customer's lower half. Also during the virtual fitting session, the customer can be provided with an options input box 1112 that comprises a link enabling the customer to add the piece of merchandise to their virtual shopping cart 1116, a link enabling the release of their data to other parties 1120, and/or a link enabling the customer to provide direct feedback via a customer survey 1124.

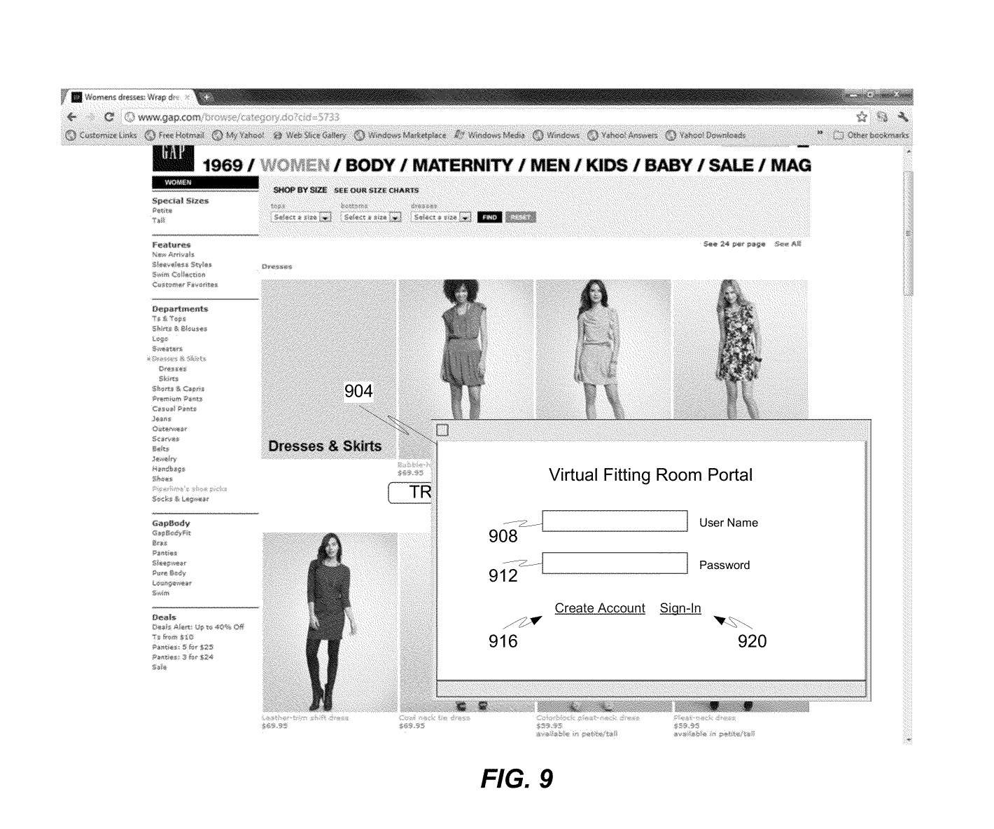

Referring back to step 712, if the customer's dimension data is not directly available to the merchandise server 332, then the merchandise server 332 initiates a data exchange with the fitting server 310 to provide the merchandise dimension data to the fitting server 310 (step 724). As an alternative, during the data exchange the merchandise server 332 may first provide a password to the fitting server 310 and if that password is found to be valid, then the customer's dimension data may be provided back to the merchandise server 332. If the merchandise dimension data is provided to the fitting server 310, then a second web session (separate from the first web session) may be automatically launched between the customer and the fitting server 310 (step 728). An example window for the second web session 904 is depicted in FIG. 9. In some embodiments, prior to establishing the second session, the customer may need to provide the fitting server 310 with login information via a user name field 908, a password field 912 and by clicking a sign-in link 920. If, however, the customer does not already have an account with the fitting server 310, then the customer may be asked to create an account 916. Once the customer's account is created, the customer may either be asked about their dimensions or the customer may be allowed to upload one or more self-obtained images. The data obtained from the customer may then be used to create an Avatar that is not necessarily as precise as an Avatar that would be created by using components of the platform 208.

Once the virtual fitting session has been established in the second web session, the customer may be allowed to view the fitting images 1020, 1104 and perform other functions consistent with a virtual fitting session. As an example, the customer may be provided with a fitting tab 1008 that enables the customer to obtain different views of their Avatar with the virtual merchandise fit thereon, a dimensions tab 1012 that enables the customer to update or edit their dimension data, and/or a feedback tab 1016 that enables the customer to provide direct or indirect feedback to the fitting server 310.

As another example, the customer may be allowed to re-position garments on their Avatar to have the garment placed close to whether the customer would likely wear the garment. Specifically, some customers may prefer to wear skirts or jeans lower on their hips whereas other customers may prefer to wear the same skirts or jeans higher on their hips. The virtual fitting session may enable a customer to re-position the garment on their Avatar to obtain a true fit for their preference.

After the fitting module 312 has completed fitting the merchandise to the Avatar of the customer and the customer has viewed the virtual fit of the merchandise, the fit data obtained by the fitting module 312 may be provided back to the merchandise server 332 (step 732). This allows the merchandise server 332 to understand what transpired during the virtual fitting session which may or may not provide insight as to why a subsequent transaction occurs or does not occur.

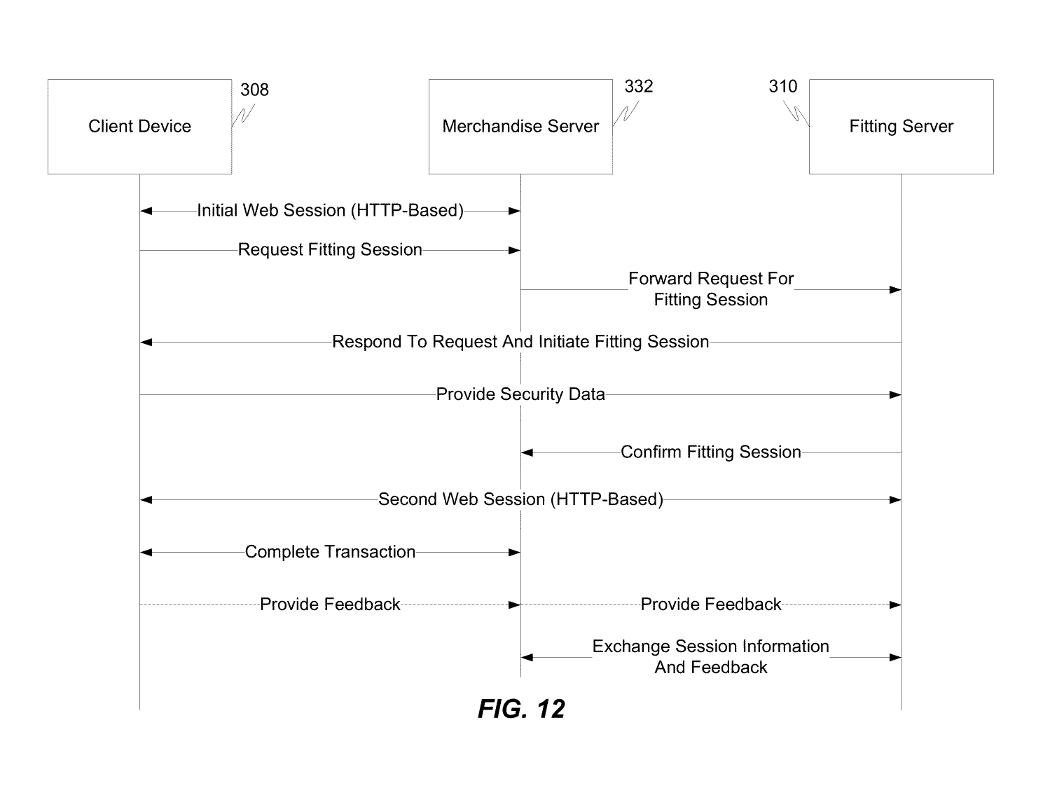

One non-limiting example of a message exchange used to implement step 724, 728, and 732 is depicted in FIG. 12. It should be appreciated that different message exchanges may be implemented if the merchandise server hosts the virtual fitting session, if the customer dimension data is not secured, etc.

After the virtual fitting session has ended (whether hosted by the fitting server or merchandise server) (step 736), the method continues with the completion of a transaction by the transaction module 340 if the transaction is requested by the customer (step 740). In some embodiments, the fitting server 310 may execute the transaction rather than the merchandise server 332. It may also be possible to obtain customer feedback (step 744) and distribute that feedback among the entities that did not directly receive the customer feedback (step 748). These message exchanges are also depicted in FIG. 12.

In the foregoing description, for the purposes of illustration, methods were described in a particular order. It should be appreciated that in alternate embodiments, the methods and steps thereof may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
obtaining one or more images of a customer;
transforming scanned vertex data from the one or more images into Avatar data configured to create a dimensional model of the customer;
securely storing the Avatar data; and
conditioning release of the Avatar data upon receiving a valid password.

2. The method of claim 2, further comprising:
receiving merchandise dimension data for a first piece of merchandise;
virtually draping the first piece of merchandise over the dimensional model of the customer by processing the Avatar data simultaneous with the merchandise dimension data; and
obtaining a goodness of fit based on the virtual draping.

3. The method of claim 3, wherein the goodness of fit is specific to the customer and is based upon information obtained from the customer after the one or more images of the customer have been obtained.

4. The method of claim 4, wherein the information obtained from the customer is obtained via at least one of a customer survey and an image obtained from a publicly-available website.

5. The method of claim 4, wherein the information obtained from the customer is obtained by analyzing merchandise returns of the customer.

6. The method of claim 4, wherein the information obtained from the customer is obtained from a customer feedback survey.

7. The method of claim 4, wherein the information obtained from the customer is obtained indirectly from the customer.

8. The method of claim 1, wherein securely storing the Avatar data comprises encrypting the Avatar data.

9. A non-transitory computer-readable medium comprising instructions stored thereon, the instructions being configured to be executed by a processor and comprising:
instructions configured obtain one or more images of a customer;
instructions configured to transform scanned vertex data from the one or more images into Avatar data configured to create a dimensional model of the customer;
instructions configured to securely store the Avatar data; and
instructions configured to condition release of the Avatar data upon receiving a valid password.

10. The computer-readable medium of claim 9, further comprising:
instructions configured to receive merchandise dimension data for a first piece of merchandise;
instructions configured to virtually drape the first piece of merchandise over the dimensional model of the customer by processing the Avatar data simultaneous with the merchandise dimension data; and
instructions configured to obtain a goodness of fit based on the virtual draping.

11. The computer-readable medium of claim 10, wherein the goodness of fit is specific to the customer and is based upon information obtained from the customer after the one or more images of the customer have been obtained.

12. The computer-readable medium of claim 11, wherein the information obtained from the customer is obtained via at least one of a customer survey and an image obtained from a publicly-available website.

13. The computer-readable medium of claim 11, wherein the information obtained from the customer is obtained by analyzing merchandise returns of the customer.

14. The computer-readable medium of claim 11, wherein the information obtained from the customer is obtained from a customer feedback survey.

15. The computer-readable medium of claim 11, wherein the information obtained from the customer is obtained indirectly from the customer.

16. The computer-readable medium of claim 9, wherein the Avatar data is securely stored by encrypting the Avatar data.

17. A system, comprising:
an image-capture device configured obtain one or more images of a customer;
a fitting server including:
a fitting module configured to transform scanned vertex data from the one or more images into Avatar data configured to create a dimensional model of the customer
a security module configured to securely store the Avatar data and condition release of the Avatar data upon receiving a valid password; and
a presentation module configured to render displays with the Avatar data to a client device via at least one fitting Application Programmer's Interface.

18. The system of claim 17, wherein the presentation module is further configured to receive merchandise dimension data for a first piece of merchandise, virtually drape the first piece of merchandise over the dimensional model of the customer by processing the Avatar data simultaneous with the merchandise dimension data, and obtain a goodness of fit based on the virtual draping.

19. The system of claim 17, wherein the goodness of fit is specific to the customer and is based upon information obtained from the customer after the one or more images of the customer have been obtained.

20. The system of claim 19, wherein the information obtained from the customer is obtained by analyzing merchandise returns of the customer.
